(19) United States
(12) Patent Application Publication
(10) Pub. No.: US 2025/0108283 A1
(43) Pub. Date: Apr. 3, 2025

(54) SYSTEM AND METHOD FOR RECREATIONAL SPORT PARTICPATION, ALLOCATION, AND BETTING

(71) Applicants: Robert James Runka, Edmonton (CA); Samuel John Parr, Foothills (CA)

(72) Inventors: Robert James Runka, Edmonton (CA); Samuel John Parr, Foothills (CA)

(73) Assignee: Golfaday Ltd, Calgary (CA)

(21) Appl. No.: 18/479,991

(22) Filed: Oct. 3, 2023

(51) Int. Cl. A63B 71/06; G06Q 50/34

(52) U.S. Cl. CPC A63B 71/06; G06Q 50/34

(57) ABSTRACT

A dynamic, computerized, and Internet-assisted method for organizing recreational golfers in engaging in golf tournaments using a multitude of in-app options. The Golf-A-Day app utilizes a variety of unique, patentable options. This includes novel sports betting options (including “skins”), dynamic handicap changes, user score verification, and accountability checking. These features, and others, are designed to produce an outstanding recreational golf experience. The back-end structure and unique functional flow process can be used in all sport and recreational game options.

### TECHNICAL FIELD

The present invention is directed to a system and method for a computer and digitally-assisted application (“app”), which includes (but is not limited to) in-play sports betting, to include, but not limited to: electronic real-time prize pool distribution, dynamic handicap change, user score verification, and accountability checking (e.g., tee box and course awareness). Although this computer and digitized app was originally developed from the game of golf, the underlying software technology and processes are designed and intended to be used in any and all recreational sport endeavors and in a multitude of venues, including any applicable recreational sport and game environments. The underlying software process structures defines the ability of this app to add significant enjoyment and value to the recreational sport environment.

### BACKGROUND OF THE INVENTION

Recreational sports have long been a popular pastime of many Americans. Specifically, it is estimated that over 75% of Americans engage in daily recreational sport activity, with increasing organization and onboarding of these activities done through digital apps. Although the majority of this population has, in the past, been male, women have been shown to increasingly participate in app-mediated recreational sport outlets, with their numbers increasingly shown to almost equate men. Participation in recreational sport apps can take many forms, from organized leagues to relatively informal exercise groups, or general “meet-ups” to engage in relatively unstructured games. Adult participation in app-mediated recreational sports has significantly increased in the last 3-4 years, with the increase found to be due in large part to the COVID-19 pandemic. Particularly during this time, participation in app-organized recreational sport activity was found to be a significant catalyst for dealing with difficulty and a significant aid to one's personal and family mental health. Overall, participation in app-organized recreational sports has been found to improve Quality of Life (QoL) significantly and pervasively, particularly in older adults.

Although the above finding has held robust in many sports, in no sport has this finding been larger than golf. One of the world's oldest sports, the modern game of golf was invented in 15^{th}-century Scotland and, in many ways, still maintains today many of the same qualities and allure that caused its rise and continued popularity. According to statistics from the PGA Tour (accessed Jul. 16, 2023), more Americans are playing golf than ever before. Specifically, in 2022 approximately one in seven Americans played golf; those that did play were found to play fairly consistently, a finding that held true for other countries as well. Additionally, many golfers use apps, mainly for yardage assessment, but increasingly for score tracking and other round statistics, but also for swing assessment, course location, and deals on rounds. The economic benefit of the technology-directed golf has been nothing short of massive, with and estimated direct economic benefit of $101.7B (this was a significant increase from statistics gained in 2016, which demonstrated a direct benefit of “only” $84.1B). Golf's overall participation base is estimated at 41M, an increase of about 10M from 2016. In short, no other sport has experienced such unprecedented growth.

Paralleling the dramatic rise of golf in the United States has been the significant rise of sports betting. Although this phenomenon has been pronounced all over the world, nowhere has this rise been as significant as in America, where dramatic changes in legislation allowing app-mediated “live” (single game) sports betting in over 30 states has caused a significant up-tick in financial wagers placed on sporting events. For instance, In 2019 sport gamblers placed more than $13B in wagers, almost double that when compared to bets in 2018. Of note, the majority of these bets, once placed in a paper-and-pencil method by “bookies,” are now placed by computerized means, mainly via apps. The proliferation of in-app betting sites (e.g., bet365, FanDuel, BetMGM) has allowed the average sports fan to make relatively low dollar amount bets in a very accessible and efficient manner and, additionally. In so doing, it has allowed wagers to be placed on less traditional and even recreational sports. Golf, in particular, has seen a significant rise in betting, with golf betting accounting for $150M in wagers, outpacing popular sports such as NASCAR); no other sport-recreational or professional-has experienced such a significant betting surge. Additionally, the public image of betting has shifted significantly, with it being viewed much more favorably than it has in the past.

Although there has been a surge in the popularity of professional sports-betting, there has been a corresponding expansion of wagering on recreational sports. Although this has long-taken place in competition between recreational competitors (particularly in sports such as golf) the structure for this betting system has, until recently, remained relatively informal. With the rise of unique propositional bets (“prop bets”), recreational betters have enjoyed (and won and lost money) on betting on things outside of the recreational sport itself; this has become a more common occurrence in golf. The synergy of the rise of recreational sports (including golf) and recreational betting has resulted in a need for an engaging and dynamic digital solution to recreational sport player onboarding and engagement.

In addition to in-app dynamic sports betting functionality, the rise of in-app cash prizes with electronic collection and payouts and prize-pool distribution has also found to be of significant attraction to recreational athletes. Select apps have already begun to make use of this functionality, such as BetMGM, Caesers, BetRivers, and DraftKings. Despite select apps already engaging in limited payout functionality, as well as electronic currency collection, no apps currently exist that engage in legitimate and accurate in-app recreational sports currency collection and prize-pool distribution. A notable hole in the market, prize pool distribution may, in the case of Golf, take the form a “skin” (skin =prize money for winner of an individual hole). Although other recreational sports apps employ the concept of a skin (e.g., Spark Golf) there is not a direct financial payout to the participating recreational player in this case, a huge disadvantage. Of note, analogous “skin” wagers can be included in other recreational sports as well.

Given the rise in dynamic sports-betting, there has also been an increasing and pervasive need for in-app security, most notably increased transparency and verification. Such a system is integral in the foundational security and trust. The proposed system win the current proposed patent submission will include a scorecard system verification process. This process will not only be simple, but will also represent a novel and significant value-add to existing systems, which have as there main disadvantage lack of accurate verification. The above will dovetail with in-app betting to increase the trust, transparency, and ultimate legitimacy of app-based recreational play systems. To date, this has not been implemented.

### BRIEF DESCRIPTION OF THE DRAWINGS

FIG. 1. Is a schematic that details the electronic registration and general onboarding of recreational sport tournament participants.

FIG. 2. Is a schematic that details the distribution and allocation of monetary funds among recreational sport tournament participants.

FIG. 3. Is a schematic that outlines various computerized mechanisms of equalizing competitors (i.e., playing field) in recreational sport and keeping in-competition accountability and transparency.

FIG. 4. Is a schematic that outlines the proposed unique in-app betting system and dynamic side-bet mechanism.

### DETAILED DESCRIPTION OF THE INVENTION

Generally, the tools, systems, and methods described in this patent application are designed to provide recreational athletes with the opportunity to participate in organized recreational sport, which includes dynamic in-play sports betting (including electronic real-time prize pool distribution), and such features as dynamic handicap change, user score verification, and accountability checking (e.g., tee box awareness and course locator).

This system is designed to be primarily implementable in a software environment. The system may be distributed across a variety of computing devices, including intra-and internet configurations. Other computerized networking systems may also be used.

This document is organized as follows: In the first section, an overview of the techniques and implementation is provided and described along with an exemplary computerized network environment. In the next section, an exemplary work flow and implementation for the various proposed inventions is provided, including the operational functions of said proposed inventions. Finally, an exemplary computer environment for the implementation of the system and method of the present invention is described. In one exemplary aspect, the required human process, algorithms, and exercises to implement the present system and method are provided for autonomous use by consumer recreational athletes and other interested users. This may take the form of a sequenced and/or parallel method of computer-executable instructions, which are accessible over a connected network, such as the Internet or a intranet, to be delivered by popular and easy-to-use computer devices, including laptops, touch-screen tablets, and smartphones. All consumer assessment, algorithmic, and response data may be automatically accumulated, sent via the Internet to a centralized and secure database, used to customize the database and proposed patentable endeavors, and provide feedback to the users and potential financial disbursement(s).

This unique recreational competition and financial accumulation and betting system and method of the present invention may be implemented in a modular software architecture based on a service-oriented model that incorporates best practices from the Model-View-Controller (MVC) paradigm and Representational State Transfer (REST) architecture. The core of the model is a common services framework that acts as the intermediary to serve critical functions including authentication and authorization, persistence, business logic processing, and state management. This layer abstracts the complex business logic and technical implementations of the backend system. Specific user interface logic that is browser or mobile-device specific is contained in presentation-level views which will be discussed in more detail below. Persistent storage may be represented by a relational database platform.

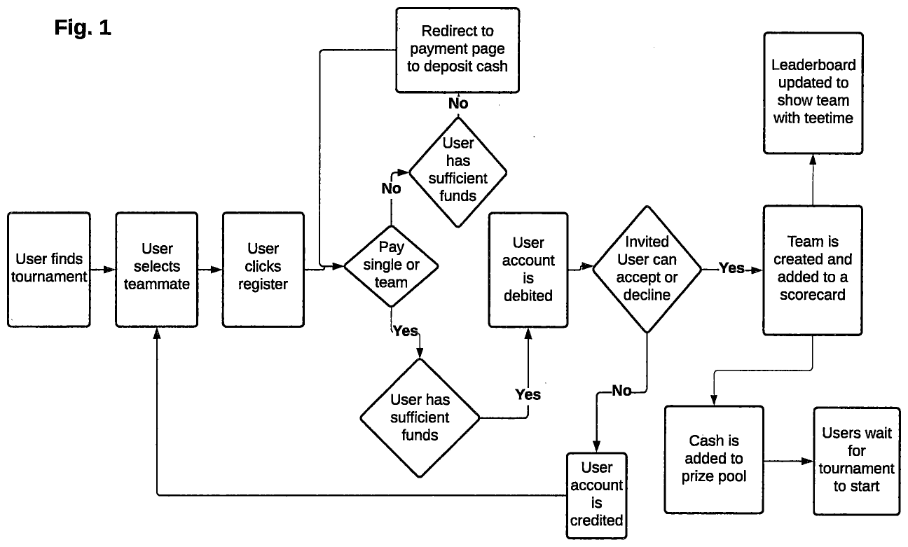

Referring to the drawings, and initially to FIG. 1, an exemplary system for implementing the method of consumer recruitment and organization is provided and is identified as reference number 100. In general, the system 100 may include a communication network 102, such as a Local Area Network (LAN), Wide Area Network (WAN) (e.g., Internet), wireless network or other similar configuration for allowing communication among two or more computing devices. Connected to network 102 may be a user device 104 that is operated by recreational athletes and any interested users of the present invention. User device 104 may include devices such as handheld devices, smart-phone, tablets, smart watch, augmented reality glasses, laptop computers or personal computers, which may be located in a home, office, or other environment, and that provide an interface for user interaction with local or remote applications or systems. Further, user device 104 may configured to communicate with a server 106 (or central computing device) through network 102 either through a wireless or wired connection, wherein server 106 includes a memory 108 that is used to store the organizational method, which is identified with reference number 110. Server 106 may be utilized to provide any one or more of a variety of functions including serving as a web server, data store, an application server and/or provide other services. Server 106 may include a platform architecture based on an implementation of Representational State Transfer (REST) pattern to provide for highly maintainable and performing applications. Server 106 may serve as a platform for website and mobile applications designed for consumption through various mediums, including but not limited to any of the forms of user devices mentioned above.

With continued reference to FIG. 1, the onboarding of recreational participants (110) may include an onboarding application programming interface (API) 112, an onboarding module engine 114, and a recreational sport registration module 116. Onboarding API 112 operates to formally structure the relationship between onboarding protocol and the interaction of the potential participant with the user using user device 104. For example, onboarding API 112 may be used to collect the following personal and demographic data that results from a user interacting with the onboarding protocol displayed on user device 104:
Onboarding ID (int)-used to uniquely identify the potential recreational athlete in tournament competition within a library of other participants (118) including a plurality of other athletes stored in memory 108;
Demographic Title (string)-descriptive title that can be displayed for the individual recreational participants:
Demographic Team (string)-used to identify a potential team or group that the individual participant may choose to align themselves with, stored in library 118;
Number of Competitions Participated In (int)-used to collect the amount of tournaments of competitions participated in by the individual recreational athletes;
Measureable (wins/losses)-used to identify the wins and losses of individual participant and/or team;
Result (wins/losses)-used to determine overall wins/losses;
Type of Sport (int)-used to identify the type of recreational sport played; valid enumeration of levels of difficulty;

Onboarding module 110 may be dynamic in that it improves in accuracy each time a user onboards and engages in their in-app activities. Exemplary personalization parameters that may be used by 114 to customize the user experience include, but are not limited to, one or more of user background information and other demographic information. Initially, module 114 utilizes the personalization parameters in conjunction with demographic background information. Module 110 may further personalize and dynamically change the type and quality of user interface experience throughout the app. Additionally, various techniques may be used to minimize the risk of introducing security vulnerabilities. One approach may be based on the GOOGLE®CAJA project, which enables third party embedding of scripts.

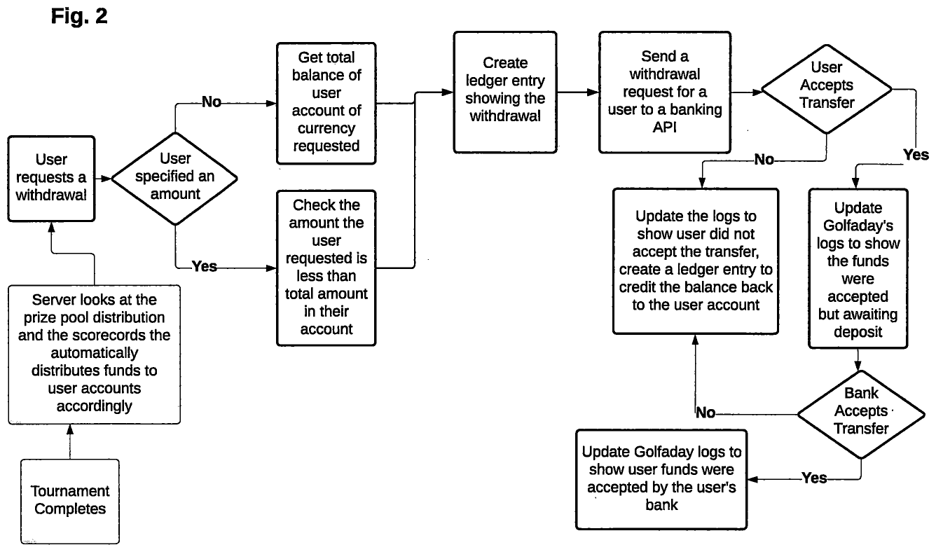

In accordance with an aspect of the present invention, with reference to the flow chart 200 set forth in FIG. 2, module 110 may be used in conjunction with system 100 to execute a method for assessing and equalizing sport ability, such as that employed by equalizing Tee Boxes. This will take various forms, but also incorporate multiple personalization parameters, as provided by the user, at step 202; allowing for the display of at least one play equalization position at step 204; allowing the user to interact with the at least one more playing equalization decision on the interaction of the at least one unit of demographic information by the user at step 208; generating at least one equalization decision based at least in part on the demographic and playing history data at step 210; and utilizing the score and the at least one demographic personalization parameter to generate a equalization decision score(s) at step 212, wherein the generated equalization score is utilized in determining a subsequent equalization decision to be displayed to the user, at step 214. The method may then repeat by returning to step 204. It should be understood that the user may update his or her personalization parameter(s) over time, wherein the updated personalization parameters may then be used to generate the respective equalization decision score. The aspects of the present invention and the advantages thereof can be further appreciated by considering a representative implementation described with reference to FIG.'s 1-4 and other associated descriptions.

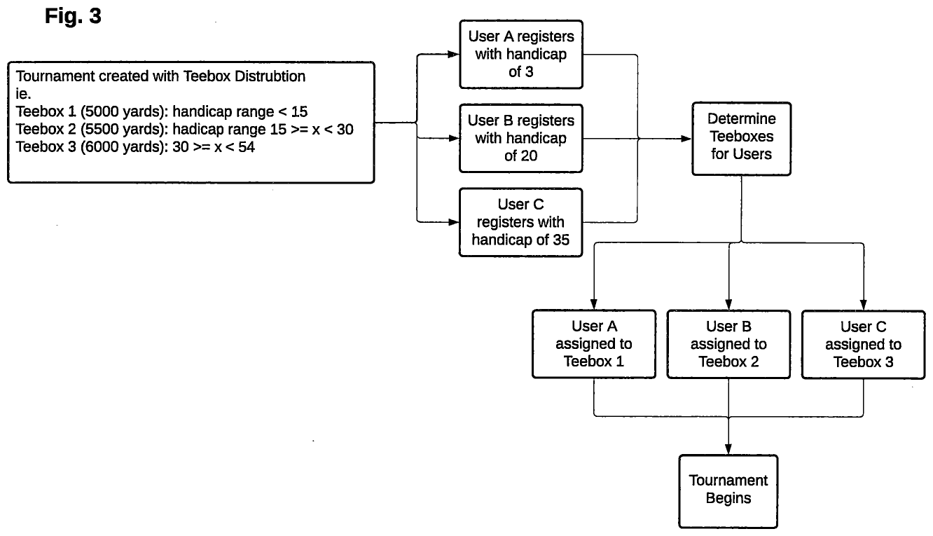

FIG. 3 illustrates an example of a process of increasing fairness and accurate in-game scoring. In this exemplar this concept involves validation of the scorecard by opposing players and/or teams. This may involve showing a score input screen (300) that may be displayed to a user on user device 104 through the operation of demographic module 110. The score input screen 300 allows user to access his or her user profile stored in a user profile data base 122 (FIG. 1), associated data required to start or continue the recreational play option using equalization score module 110, and selected activities that re accessible from user device 104. A simple screen image is displayed, with a score input button 302 that may be clicked for a user with an existing profile to connect and input data in user profile database 122, and a sign up button 304 for new users to register with the system, and an online help button 306 if more information is required. For existing users, fields 308, 310 are provided for user identification and password entry. If errors are made during data entry, appropriate error messages are displayed on user device 104. Input and validation errors will be allowed to be corrected.

With additional reference to FIG. 3, the work flow begins with a determination of whether the user is an existing user at step 312. If the user is an existing user at step 312, login button 302 is selected at step 314. Thereafter, a user login identification is entered in field 308 at step 316,and a user password is entered in field 310 at step 318. Demographic module 110 may then determine if the entered user login identification and user password match an existing user login identification and user password stored in user profile data base 122. If there is a match at step 320, then the work flow continues. If there is no match at step 320, then the work flow reverts to step 316. If the user is a new user at step 312, sign up button 304 is selected at step 322 and the work flow continues.

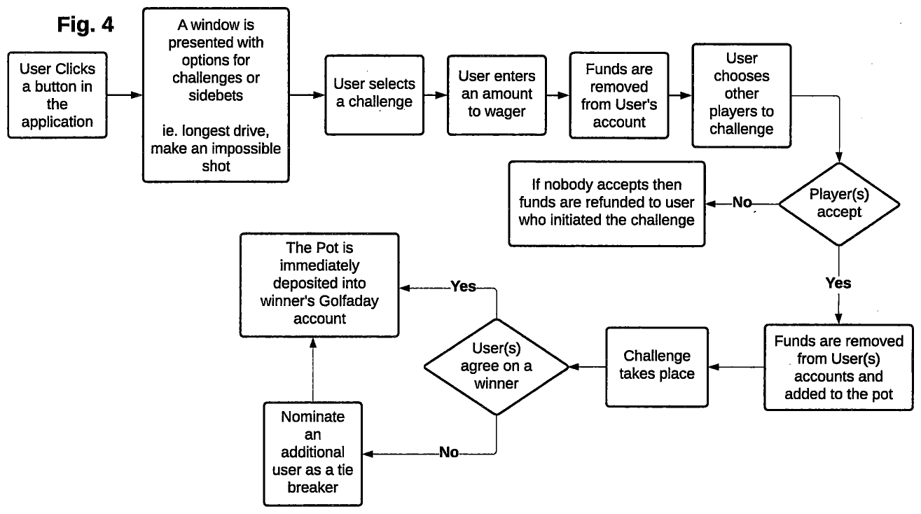

FIG. 4 illustrates a basic overview depiction of a new user flow in engagement of an in-app dynamic betting system. This involves, but is not limited to, a registration screen 400 that may be displayed to a user device 104 through the operation of onboarding demographic module 110. New user registration screen 400 allows the new user to enter and store required information in user profile database 122, such as, but not limited to, a valid user first name in field 402, last name in field 404, display name in field 406, email address in field 408, phone number in field 409, and password in field 410. The password may be specified a second time in field 412 for validation and confirmation with the password that was entered in field 410. Appropriate help messages and prompting are included for easy use. On this screen, there is also a help button 414 to get additional guidance, and a user image button (not shown) to bring up other options which will be described in relation to other screen shots.

With additional reference to FIG. 4, the work flow continues from step 322 in FIG. 3 whereby the valid user first name is entered in field 402 at step 416, last name is entered in field 404 at step 418, display name is entered in field 406 at step 420, email address is entered in field 408 at step 422, and password is entered in field 410 at step 424. The password may be entered a second time in field 412 at step 426 for validation and confirmation with the password that was entered in field 410. After the aforementioned user information is entered, the sign up button 428 is selected at step 430, and the work flow proceeds to an initial cognitive assessment whereby one or more personalization parameters from the user related to user background demographic information 110 and sport competition scores.

It will be appreciated that the network connections shown herein are merely exemplary, and it is within the scope of the present invention to use other types of network connections between server 106, user device 104, and third party computing device 120 including both wired and wireless connections. From the foregoing, it will be seen that this invention is one well adapted to attain all the ends and objects herein above set forth together with other advantages which are obvious and which are inherent to the method and apparatus.

It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting. The constructions described above and illustrated in the drawings are presented by way of example only and are not intended to limit the concepts and principles of the present invention. As used herein, the terms “having” and/or “including” and other terms of inclusion are terms indicative of inclusion rather than requirements. While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A computer-implemented method for organizing, onboarding, and engaging in competitive recreational sports. Wherein a processor is programmed for executing the method comprising: receiving at least one personalization parameter (e.g., username) from a computing device provided by the user; allowing for an onboarding mechanism displayed on a display of the user computing device; allowing the user to interact with the onboarding mechanism using the user computing device; receiving data from the user computing device based on the interaction of at least one computer-generated data-point by the user; generating a score or set of scores based at least-in part-on the received data; applying weighting factors to the generated first score and said at least one personalization parameter; utilizing the applied weighting factors of the first score and at least one demographic parameter to generate a score or set of scores based at least in part on said demographic score; allowing for the display of said at least one score or set of scores; and allowing the user to interact with at least one score or set of scores, wherein said interaction with said at least score or set of scores by the user allows increased equalization of participation and increased general participation in a recreational sporting event. ·

2. A computer-implemented method in accordance with claim 1, wherein the at least one personalization parameter is one or more of background information of the user and demographic aspects of the user.

3. A computer-implemented, digitally-mediated method in accordance with claim 2, wherein the background information of the user includes one or more of the user's date of birth, gender, marital status, city of residence, highest education completed, work status, occupation, interests, personality characteristics, and motivation.

4. A computer-implemented, digitally-mediated, method in accordance with claim 2, wherein the personalization parameters of a user includes one or more of the following: username, password, etc. or other unique identifying information.

5. A computer-implemented, digitally-mediated method in accordance with claims 1-3, wherein the data includes in-app dynamic betting, to include, but not limited to, individual and team betting. This is also to include the collection, storage, and disbursement of funds in accordance with the terms of the event registration and/or agreed upon in-app wager.

6. A computer-implemented, digitally-mediated method in accordance with the aforementioned claims, further comprising the step of providing motivation to the user during the interaction with the at least one question or set of questions allowing equalization and entry into the computer-mediated recreational sporting event.

7. A computer-implemented, digitally-mediated method in accordance with the aforementioned claims, wherein the interaction with the aforementioned recreational sport computerized exercises does not require actual sport or otherwise physical activity.

8. A computer-implemented, digitally-mediated method in accordance with the aforementioned claims, wherein the physical activity is limited to use of a keyboard.

9. A non-transitory computer readable medium having thereon computer executable instructions for performing a computer-implemented, digitally mediated method for organizing, implementing, making fair, and engaging in dynamic betting for recreational sport athletes.
